(19) United States
(12) Patent Application Publication
(10) Pub. No.: US 2025/0151720 A1
(43) Pub. Date: May 15, 2025

(54) METHOD FOR CONTROLLING AN INSECT

(71) Applicant: SUMITOMO CHEMICAL COMPANY, LIMITED, Tokyo (JP)

(72) Inventors: Kazuyo MIYAMOTO, Osaka-shi (JP); Yoshito TANAKA, Osaka-shi (JP); Osamu HOSHINA, Osaka-shi (JP); Takashi KUROSAWA, Tokyo (JP); Goro TAJIKA, Tokyo (JP); Suguru IKUTA, Tokyo (JP); Yuji UCHIDA, Tokyo (JP); Atsushi SHIBAYAMA, Tokyo (JP)

(73) Assignee: SUMITOMO CHEMICAL COMPANY, LIMITED, Tokyo (JP)

(21) Appl. No.: 19/022,260

(22) Filed: Jan. 15, 2025

Related U.S. Application Data
(62) Division of application No. 16/491,461, filed on Sep. 5, 2019.

(30) Foreign Application Priority Data
Mar. 6, 2017 (JP) 2017-041963

(51) Int. Cl. A01N 25/34; A01M 1/20; A01N 25/18; A01N 43/40

(52) U.S. Cl. CPC A01N 25/34; A01M 1/20; A01N 25/18; A01N 43/40

(57) ABSTRACT

An object is to provide a high insect control effect on larvae of stored grain insect pests that occur in a deposit of grain powder, which have been difficult to control by conventional insecticide application or fumigant treatment, and make it possible to easily carry out control even in places that are difficult to clean to remove grain powder. A three-dimensional insect control sheet (10) contains an insect growth regulator at least in a front surface (1a) and has a three-dimensional surface that forms a structure with an irregular profile. The front surface (1a) is at least part of the surface with the irregular profile.

### CROSS-REFERENCE TO RELATED APPLICATIONS

This application is a Divisional application of co-pending application Ser. No. 16/491,461, filed on Sep. 5, 2019, which is the National Phase under 35 U.S.C. § 371 of International Application No. PCT/JP2018/007863, filed on Mar. 1, 2018, which claims the benefit under 35 U.S.C. § 119 (a) to Patent Application No. 2017-041963, filed in Japan on Mar. 6, 2017, all of which are hereby expressly incorporated by reference into the present application.

### TECHNICAL FIELD

The present invention relates to a three-dimensional insect control sheet for control of stored grain insect pests.

### BACKGROUND ART

Insect pests that occur in houses, buildings, warehouses, plants, and factories and the like, such as sanitary insect pests, nuisance insect pests, wood insect pests, and stored grain insect pests, have been causing an increasing number of kinds of damage. Methods of controlling such insect pests that have been carried out are spraying of an insecticide such as that in the form of an aerosol and a fumigant treatment. In recent years, there has been an increasing demand for an insect control sheet which contains an agent that has an insect control effect. For example, Patent Literature 1 discloses a method of repelling insect pests from a food/beverage container. The method includes: placing, in the food/beverage container, an insect pest repellent sheet that contains a room-temperature-volatile insect pest repellent component whose odor is unlikely to be transferred to food/beverage; and thereby preventing insect pests from entering the food/beverage container over a long period of time of more than three months. According to the method disclosed in Patent Literature 1, the room-temperature-volatile insect pest repellent component is volatilized from the insect pest repellent sheet at a rate of 1 mg to 200 mg per day per square meter of the sheet.

Patent Literature 2 discloses an insect-pest-repellent, sheet-form laminate that shows an insect control effect. The insect-pest-repellent, sheet-form laminate has a layered structure composed of (i) two sheet layers of the same kind or different kinds and (ii) an agent-containing resin layer that contains a pyrethroid-based agent and that is sandwiched between the two sheet layers. At least one of the two sheet layers is an agent-permeable sheet layer that is permeable to the pyrethroid-based agent.

Patent Literature 3 discloses a crawling pest repellent that contains therein or has supported thereon (i) a crawling pest repelling component that is p-menthane-3,8-diol and/or p-menthane-1,8-diol and (ii) an effect-enhancing agent selected from 1,3-butylene glycol, diethylene glycol monobutyl ether, dipropylene glycol monomethyl ether, and 1-methoxy-1,2-propanediol.

Patent Literature 4 discloses an insect control resin composition composed of 1-methyl-2-nitro-3-[(3-tetrahydrofuryl)methyl] guanidine contained in a polyolefin-based resin. Patent Literature 4 also discloses an insect control molded article produced from the insect control resin composition.

Patent Literature 5 discloses an insect control sheet that contains one of and/or two or more of obacunone, nomilin, limonin, deoxylimonin, deacetylnomilin, and limonexic acid.

Non-patent Literature 1 discloses an agent in a tape form that contains a pyriproxyfen component. Pyriproxyfen is an insect growth regulator, and acts to inhibit the hatching of laid eggs without showing insecticidal activity with respect to adult insects under the family Aleyrodidae.

Non-patent Literature 2 discloses an insect-pest-repellent, coated plywood board that shows an insect pest repellent effect. Non-patent Literature 3 discloses a repellent member in the form of film tape that shows an insect pest repellent effect.

### CITATION LIST

### Patent Literature

[Patent Literature 1]
Japanese Patent Application Publication, Tokukai, No. 2012-254963 (Publication date: Dec. 27, 2012)
[Patent Literature 2]
Japanese Patent Application Publication, Tokukai, No. 2010-285417 (Publication date: Dec. 24, 2010)
[Patent Literature 3]
Japanese Patent Application Publication, Tokukai, No. 2014-24868 (Publication date: Feb. 6, 2014)
[Patent Literature 4]
Japanese Patent Application Publication, Tokukai, No. 2002-47110 (Publication date: Feb. 12, 2002)
[Patent Literature 5]
Japanese Patent Application Publication, Tokukaihei, No. 1-265006 (Publication date: Oct. 23, 1989)

### Non-patent Literatures

```
  [Non-patent Literature 1]
  “LANO (registered trademark) TAPE”, [online], [Searched on March 14, 2016],
Internet <URL: http://www.i-nouryoku.com/prod/PDF/0787 [symbol]   .pdf>
  [Non-patent Literature 2]
  “MushiBlock(insect repellent)-coated sheet (insect-pest-repellent, coated
plywood board)”, [online], [Date of search: March 14, 2016], Internet <URL:
http://www.earth-chem.co.jp/company/collaboration/pdf/details_003.pdf>
  [Non-patent Literature 3]
  “Mushi-block tape N (repellent member in the form of film tape)”, [online], [Date
of search: March 14, 2016], Internet <URL: http://www.earth-
chem.co.jp/company/collaboration/pdf/details_011.pdf>
```

### SUMMARY OF INVENTION

### Technical Problem

Incidentally, food factories, milling factories, and warehouses that deal with grain powder such as wheat flour have recently been suffering serious damage caused by insect pests that eat and damage stored grain, that is, so-called stored grain insect pests. If stored grain insect pests occur in a food factory, a fumigant treatment or insecticide spraying is carried out in order to control the insects. In so doing, food production is ceased and the control takes a certain period of time to complete, resulting in a decrease in food production efficiency. Furthermore, in order to prevent an insecticidal component from contaminating a food production line, it is necessary to cover the food production line with a protective material. In addition, even after the completion of the control, it is necessary to clean the portion of the food production line covered with the protective material. There has been a demand for reducing time and labor taken for such pest control.

Furthermore, generally, adult stored grain insect pests lay eggs in places where there is a deposit of grain powder, that is, in a powder heap. Larvae of stored grain insect pests hatched from the eggs feed on grains of the powder heap and grow inside the powder heap. One way to prevent such growth would be to eliminate powder heaps by frequently cleaning the inside of the food factory; however, there are some places that are difficult to frequently clean to remove powder heaps, such as, for example, places at height in the food factory. These places are sources of occurrence of stored grain insect pests.

Conventional techniques such as the foregoing fumigant treatment and insecticide spraying are not sufficiently effective for the larvae growing inside the powder heaps, and cannot be put in practical use.

Under such circumstances, there has been a strong demand for a method of stored grain insect pest control which is sufficiently effective for stored grain insect pests inside powder heaps and which can be easily carried out even in a place that is difficult to clean.

An aspect of the present invention was made in view of the above issue, and an object thereof is to realize a three-dimensional insect control sheet that shows an insect control effect on larvae of stored grain insect pests inside powder heaps, which have been difficult to control by conventional techniques, and that is capable of easily controlling insect pests even in a place that is difficult to clean.

### Solution to Problem

In order to attain the above object, a three-dimensional insect control sheet in accordance with an aspect of the present invention has a three-dimensional surface that forms a structure with an irregular profile, the three-dimensional insect control sheet containing an insect growth regulator, the insect growth regulator being contained at least in a front surface of the three-dimensional insect control sheet, the front surface being at least part of the structure with the irregular profile.

### Advantageous Effects of Invention

An aspect of the present invention provides the following effect: it is possible to show an insect control effect on larvae of stored grain insect pests inside powder heaps, which have been difficult to control by conventional techniques, and easily control insect pests even in a place that is difficult to clean.

### BRIEF DESCRIPTION OF DRAWINGS

FIG. 1 illustrates a configuration of a three-dimensional insect control sheet in accordance with Embodiment 1 of the present invention. (a) of FIG. 1 is a perspective view, (b) of FIG. 1 is a side view, and (c) of FIG. 1 is a side view of the three-dimensional insect control sheet which has deposited thereon grain powder that can serve as food for larvae of stored grain insect pests.

FIG. 2 illustrates a variation of a three-dimensional insect control sheet in accordance with Embodiment 1 of the present invention. (a) of FIG. 2 is a perspective view, and (b) of FIG. 2 is a side view.

FIG. 3 illustrates a configuration of a three-dimensional insect control sheet in accordance with Embodiment 2 of the present invention. (a) of FIG. 3 is a perspective view, (b) of FIG. 3 is a top view, and (c) of FIG. 3 is a side view.

FIG. 4 illustrates a configuration of a three-dimensional insect control sheet in accordance with Embodiment 3 of the present invention. (a) of FIG. 4 is a perspective view, (b) of FIG. 4 is a top view, and (c) of FIG. 4 is a side view

### DESCRIPTION OF EMBODIMENTS

### Embodiment 1

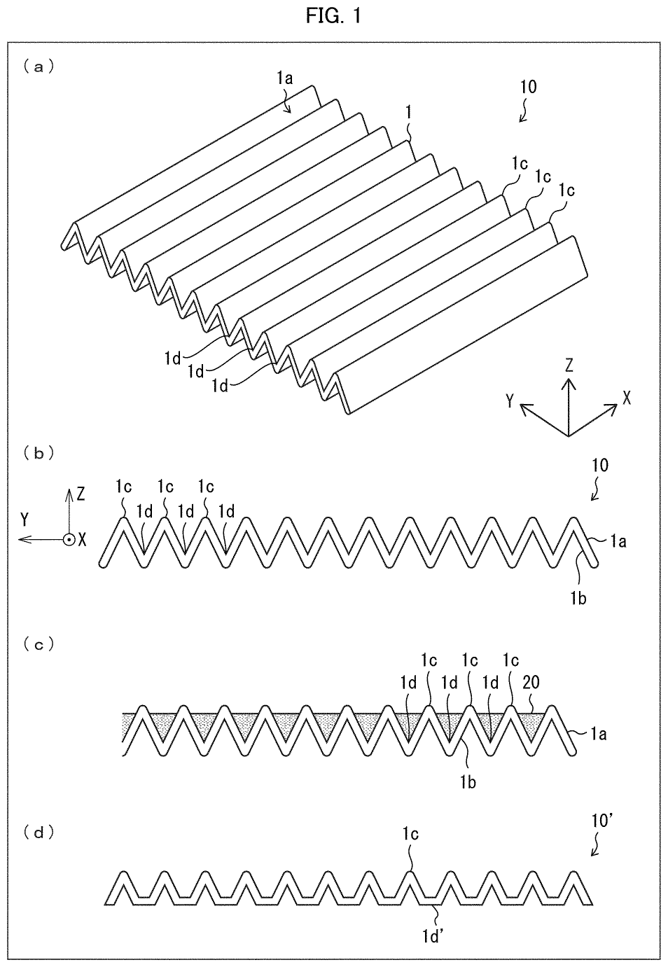

The following description will discuss an embodiment of the present invention in detail. FIG. 1 illustrates a configuration of a three-dimensional insect control sheet 10 in accordance with Embodiment 1. (a) of FIG. 1 is a perspective view of the three-dimensional insect control sheet 10, (b) of FIG. 1 is a side view of the three-dimensional insect control sheet 10, and (c) of FIG. 1 is a side view of the three-dimensional insect control sheet 10 which has deposited thereon grain powder that can serve as food for larvae of stored grain insect pests.

As illustrated in (a) and (b) of FIG. 1, the three-dimensional insect control sheet 10 in accordance with Embodiment 1 is a sheet body 1 that has: a front surface la on which powder deposits; and a back surface 1b. An insect growth regulator need only be contained in at least the front surface 1a, of the front surface 1a and the back surface 1b of the sheet body 1. The insect growth regulator does not need to be contained in the back surface 1b.

The entire surface of the sheet body 1 is constituted by a three-dimensional surface that has a structure with an irregular profile. More specifically, the front surface 1a of the sheet body 1 is a three-dimensional surface that has a corrugated structure, and has repeatedly arranged ridges 1c and valleys 1d each of which extends in a certain direction. That is, the three-dimensional insect control sheet 10 is in a corrugated shape that is obtained by folding a sheet into a wavy form.

The three-dimensional insect control sheet 10 can be placed in any places in which grain powder is likely to deposit and which are difficult to clean, such as, for example, places at height, places below and inside large machinery, and the like places, in food factories, milling factories, warehouses and the like which deal with grain powder such as wheat flour. Other examples of a suitable place to place the three-dimensional insect control sheet 10 include places near cooking machinery which require time and labor to spray an insecticide to. The three-dimensional insect control sheet 10 is placed with the front surface 1a facing up. It should be noted here that a direction perpendicular to a plane on which the three-dimensional insect control sheet 10 is placed is referred to as a Z direction, a direction in which each of the ridges 1c and valleys 1d extends is referred to as an X direction, and a direction perpendicular to both the X direction and the Z direction is referred to as a Y direction.

When the three-dimensional insect control sheet 10 is placed in advance in a place where grain powder is likely to deposit, the front surface 1a will have deposited thereon a powder layer 20 composed of grain powder, as illustrated in (c) of FIG. 1. The powder layer 20, which serves as food for larvae, is a place where adult stored grain insect pests will lay eggs.

The insect growth regulator contained in the three-dimensional insect control sheet 10 inhibits hatching of the eggs of the stored grain insect pests, and also inhibits growth of and adult eclosion from larvae. It is therefore possible to achieve a long-term insect control effect. Also by replacing three-dimensional insect control sheets 10 at a certain time interval, it is possible to achieve a long-term insect control effect.

Places at height in a food factory or the like are difficult to clean and can be sources of occurrence of stored grain insect pests. Furthermore, places near cooking machinery require time and labor to spray an insecticide to. Placing the three-dimensional insect control sheet 10 somewhere like a place at height or a place near cooking machinery makes it possible to effectively and easily carry out insect pest control.

As used herein, the term “corrugated shape” refers to a shape which has inclined faces and in which the ridges 1c and valleys 1d are repeated along an in-plane direction of the sheet body 1. In the configuration illustrated in (a) to (c) of FIG. 1, the corrugated shape is comprised of inclined faces, and each of the ridges 1c and valleys 1d is formed in a straight line where two inclined faces meet. Note, however, that the ridges 1c and the valleys 1d are not particularly limited as to their shapes, provided that there is a height difference between the ridges 1c and the valleys 1d. The ridges 1c and the valleys 1d may have flat surfaces. For example, a three-dimensional insect control sheet 10′ illustrated in (d) of FIG. 1 has a corrugated shape in which valleys 1d′ have flat bottoms.

The upper limit of the height in the Z axis direction of the structure with an irregular profile formed by the three-dimensional surface of the three-dimensional insect control sheet 10 is preferably 30 mm, more preferably 20 mm. The lower limit is preferably 5 mm, more preferably 10 mm. The ranges defined by the above upper limits and lower limits are suitable from the viewpoints of convenience and insect control effect.

The upper limit of the angle of each vertex of the structure with an irregular profile (corrugated shape) is preferably 90°, more preferably 60°, particularly preferably 55°. The lower limit is preferably 10°, more preferably 40°, particularly preferably 45°.

Note that a three-dimensional insect control sheet in accordance with the present invention can be placed in a bent state in a case where a placement location is not flat, such as a case where the three-dimensional insect control sheet is placed on a pipe.

### (Insect Pests Targeted by Three-Dimensional Insect Control Sheet 10)

Examples of insect pests on which the use of the three-dimensional insect control sheet 10 in accordance with Embodiment 1 can show an excellent insect control effect include general stored grain insect pests. More specific examples include: insects under the family Curculionidae such as Sitophilus zeamais (maize weevil) and Sitophilus oryzae (rice weevil); insects under the family Bruchidae such as Callosobruchus chinensis (adzuki beam weevil) and Bruchus pisorum (been weevil); insects under the family Anthribidae such as Araecerus coffeae (coffee bean weevil); insects under the family Anobiidae such as Lasioderma serricorne (cigarette beetle) and Stegobium paniceum (drugstore beetle); insects under the family Lyctidae such as Lyctus brunneus; insects under the family Silvanidae such as Oryzaephilus surinamensis (sawtoothed grain beetle) and Oryzaephilus mercator (merchant grain beetle); insects under the family Dermestidae such as Attagenus japonicus and Anthrenus verbasci (varied carpet beetle); insects under the family Pyralidae (pyralid moths) such as Plodia interpunctella (Indian-meal moth), Corcyra cephalonica (rice moth), and Cadra cautella (almond moth); insects under the family Gelechiidae such as Sitotroga cerealella (angoumois grain moth); insects under the family Tenebrionidae such as Tribolium castaneum (red flour beetle) and Alphitobius diaperinus (lesser mealworm); insects under the family Trogositidae such as Lophocateres pusillus (Siamese grain beetle) and Tenebroides mauritanicus (cadelle beetle); insects under the family Nitidulidae such as Carpophilus dimidiatus (corn-sap beetle) and Carpophilus pilosellus (dried fruit beetle); insects under the family Bostrichidae such as Rhyzopertha dominica (lesser grain borer); insects under the family Ptinidae (spider beetles) such as Ptinus japonicus (ptinid beetle); and insects under the family Liposcelididae such as Liposcelis bostrychophilus (book lice). The three-dimensional insect control sheet 10 provides a high insect control effect on any of the above listed insect pests. The three-dimensional insect control sheet 10 provides a particularly high insect control effect on insect pests such as insects under the family Curculionidae, insects under the family Silvanidae, insects under the family Pyralidae, insects under the family Anobiidae, and insects under the family Tenebrionidae. The three-dimensional insect control sheet 10 is targeted at, among the above listed example insect pests, one or two or more kinds of stored grain insect pest.

### (Agent Contained in Three-Dimensional Insect Control Sheet 10, and Sheet Body 1)

The three-dimensional insect control sheet 10 in accordance with Embodiment 1 can be placed in a place where powder heaps, which are sources of occurrence of larvae, are likely to form. In view of this, it is preferable that the sheet body 1 contains an insect growth regulator that has (i) the effect of preventing adult eclosion from larvae, (ii) the effect of preventing hatching of eggs, or both the effects (i) and (ii).

Examples of the insect growth regulator suitable for use in the three-dimensional insect control sheet 10 in accordance with Embodiment 1 include: juvenile hormone inhibitors such as hydroprene, kinoprene, methoprene, fenoxycarb, and pyriproxyfen; mite growth inhibitors such as clofentezine, diflovidazin, hexythiazox, and etoxazole; chitin synthesis inhibitors such as bistrifluron, chlorfluazuron, diflubenzuron, flucycloxuron, flufenoxuron, hexaflumuron, lufenuron, novaluron, noviflumuron, teflubenzuron, and buprofezin; adult eclosion inhibitors such as cyromazine; and endocrine disruptors such as chromafenozide, halofenozide, methoxyfenozide, and tebufenozide. Suitable examples are juvenile hormone inhibitors, and a particularly suitable example is pyriproxyfen. The amount of pyriproxyfen with which the three-dimensional insect control sheet 10 is treated is preferably 2 to 1500 mg per square meter of the footprint of the three-dimensional insect control sheet 10, more preferably 5 to 1000 mg per square meter of the footprint. As used herein, the term “footprint” refers to the area of a region occupied by the three-dimensional insect control sheet 10. Note that the insect growth regulator for use in the three-dimensional insect control sheet 10 in accordance with Embodiment 1 can contain a fungicide, an antibacterial agent, and/or the like, provided that the effects of Embodiment 1 are not impaired.

How the insect growth regulator is contained in the sheet body is not particularly limited, provided that at least the front surface la contains the insect growth regulator, and can be selected appropriately depending on the material of the sheet body 1 or the like. For example, the front surface la of the sheet body 1 may be constituted by a resin layer composed of a resin composition that contains the insect growth regulator.

In a case where the sheet body is constituted by a paper material such as filter paper, the three-dimensional insect control sheet 10 may be a sheet that is obtained by immersing the paper in a solution that contains the insect growth regulator at a certain concentration. This allows the insect growth regulator to be contained in at least the front surface 1a of the sheet body.

A material for the sheet body 1 of the three-dimensional insect control sheet 10 is not limited to a particular kind, provided that the material allows at least the front surface 1a to contain the insect growth regulator and allows formation of a three-dimensional surface. Examples of the material for the sheet body 1 include paper, polyethylene, polypropylene, and polyethylene terephthalate. Of those listed above, suitable examples from the viewpoint of durability of the sheet body 1 are polypropylene and polyethylene terephthalate.

In a case where a resin is used as a material for the sheet body 1, the sheet body 1 is not particularly limited as to its form and may be in the form of a film, a net, non-woven fabric, or the like. A suitable example is a non-woven fabric form.

In a case where the sheet body 1 is in the form of non-woven fabric, a material for the sheet body 1 is preferably non-woven polypropylene fabric or non-woven polyethylene terephthalate fabric. A suitable example of non-woven polypropylene fabric available in the market is Xavan (DuPont.). A suitable example of non-woven polyethylene terephthalate fabric available in the market is MARIX (UNITIKA LTD.).

### (Variation)

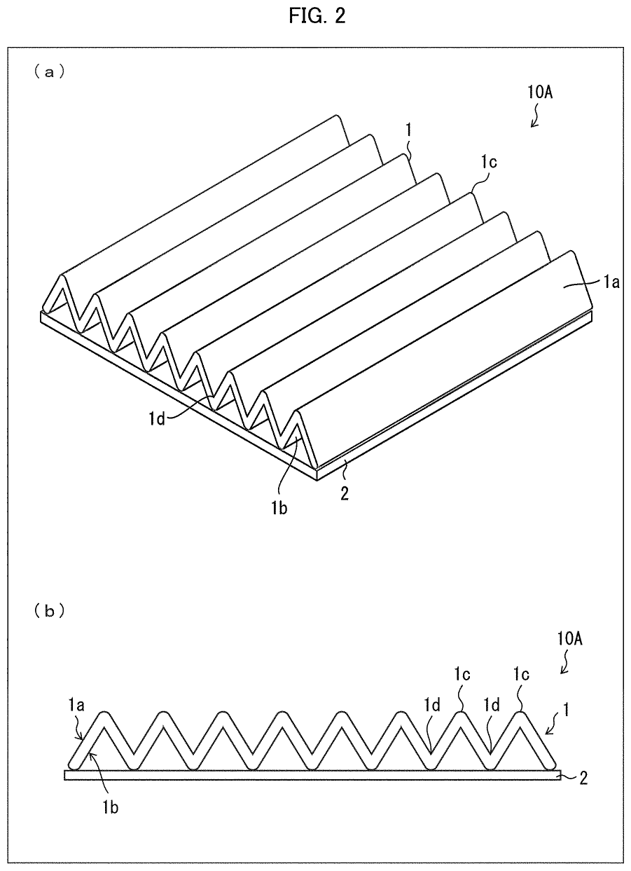

The following description will discuss a variation of the three-dimensional insect control sheet in accordance with Embodiment 1. FIG. 2 illustrates a configuration of a three-dimensional insect control sheet 10A which is the variation. (a) of FIG. 2 is a perspective view, and (b) of FIG. 2 is a side view.

As illustrated in (a) and (b) of FIG. 2, the three-dimensional insect control sheet 10A, which is a variation, includes a sheet body 1 and an adhesive sheet 2 (adhesive layer) that contains an adhesive. The adhesive sheet 2 is bonded to a back surface 1b which is on the opposite side of the sheet body 1 from a front surface 1a.

Since the adhesive sheet 2 is provided like above, the three-dimensional insect control sheet 10A is capable of being securely fixed to a mounting surface and, in turn, prevented from falling even if the sheet is placed in a place at height over a long period of time.

### Embodiment 2

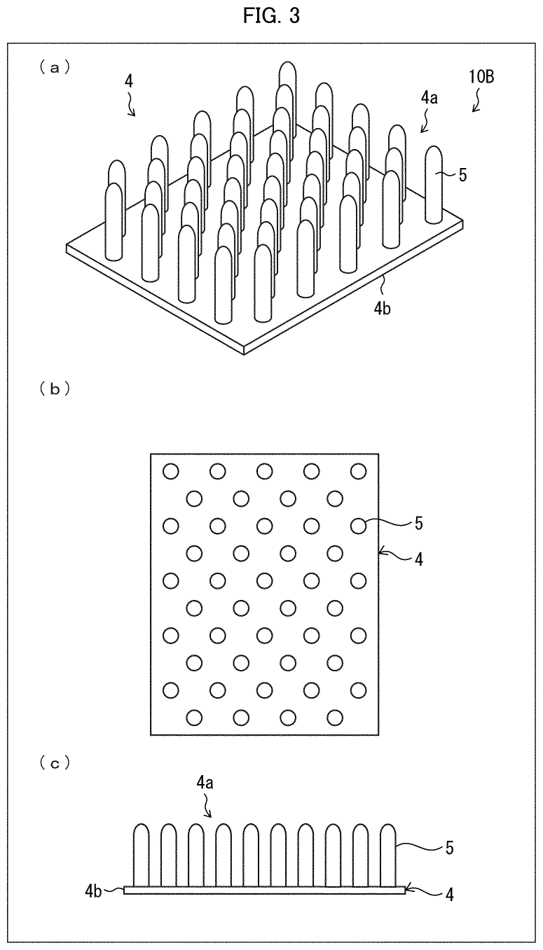

The following description will discuss another embodiment of the present invention with reference to FIG. 3. For convenience of description, members having functions identical to those described Embodiment 1 are assigned identical referential numerals, and their descriptions are omitted here.

FIG. 3 illustrates a configuration of a three-dimensional insect control sheet 10B in accordance with Embodiment 2. (a) of FIG. 3 is a perspective view, (b) of FIG. 3 is a top view, and (c) of FIG. 3 is a side view. As illustrated in (a) to (c) of FIG. 3, the three-dimensional insect control sheet 10B in accordance with Embodiment 2 is different from that of Embodiment 1 in that a front surface 4a of a sheet body 4 is a three-dimensional surface that has a projection structure (i.e., a structure that includes projections 5). A plurality of the projections 5 are projecting from a base 4b of the sheet body 4. The projections 5 are constituted by, for example, resin molded articles that contain an insect growth regulator.

As such, the front surface 4a is a three-dimensional surface that has a projection structure (i.e., a structure that includes the projections 5). Thus, when placed in a place similar to the placement locations of the foregoing three-dimensional insect control sheet 10, the three-dimensional insect control sheet 10B provides an insect control effect equivalent to that of the three-dimensional insect control sheet 10.

Note that the three-dimensional insect control sheet 10B illustrated in (a) to (c) of FIG. 3 is structured such that the base 4b has the projections 5 thereon which are resin molded articles. Note, however, that the three-dimensional insect control sheet 10B in accordance with Embodiment 2 is not limited to the structure illustrated in (a) to (c) of FIG. 3, provided that the front surface 4a is a three-dimensional surface that has a projection structure (i.e., a structure that includes the projections 5). For example, the sheet body 4 of the three-dimensional insect control sheet 10B may be a molded article that is obtained by molding the base 4b and the projections 5 in one piece.

### Embodiment 3

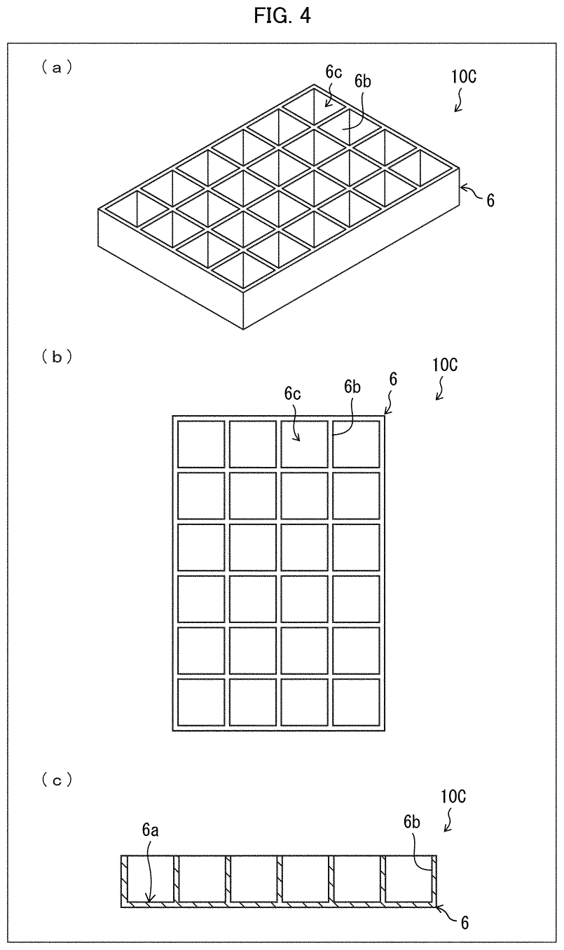

The following description will discuss a further embodiment of the present invention with reference to FIG. 4. For convenience of description, members having functions identical to those described Embodiments 1 and 2 are assigned identical referential numerals, and their descriptions are omitted here.

FIG. 4 illustrates a configuration of a three-dimensional insect control sheet 10C in accordance with Embodiment 3. (a) of FIG. 4 is a perspective view, (b) of FIG. 4 is a top view, and (c) of FIG. 4 is a side view. As illustrated in (a) to (c) of FIG. 4, the three-dimensional insect control sheet 10C in accordance with Embodiment 3 is different from that of Embodiment 1 in that the three-dimensional insect control sheet 10C has a partitioned structure (i.e., a structure that includes a plurality of compartments 6c). The compartments 6c are separated by walls 6b standing on a front surface 6a of a sheet body 6. The front surface 6a and the walls 6b of the sheet body 6 both contain an agent.

As such, the three-dimensional insect control sheet 10C has a three-dimensional surface that has a partitioned structure (i.e., a structure that includes a plurality of the compartments 6C). Thus, when placed in a place similar to the suitable example placement locations of the foregoing three-dimensional insect control sheet 10, the three-dimensional insect control sheet 10C provides an insect control effect equivalent to that of the three-dimensional insect control sheet 10.

The present invention is not limited to the embodiments, but can be altered by a skilled person in the art within the scope of the claims. The present invention also encompasses, in its technical scope, any embodiment derived by combining technical means disclosed in differing embodiments.

Aspects of the present invention can also be expressed as follows:

As has been described, a three-dimensional insect control sheet in accordance with a first aspect of the present invention has a three-dimensional surface that forms a structure with an irregular profile, the three-dimensional insect control sheet containing an insect growth regulator, the insect growth regulator being contained at least in a front surface of the three-dimensional insect control sheet, the front surface being at least part of the structure with the irregular profile.

According to the above arrangement, since the three-dimensional insect control sheet has a three-dimensional surface having a structure with an irregular profile, when, for example, the three-dimensional insect control sheet is placed in advance in a place where grain powder is likely to deposit, recesses in the structure with the irregular profile will have grain powder deposited thereon and powder heaps will form. Larvae of stored grain insect pests will grow and reproduce inside the powder heaps. The above arrangement shows an excellent insect control effect on the stored grain insect pests that occur in the powder heaps formed in the recesses of the three-dimensional insect control sheet.

Furthermore, by replacing the three-dimensional insect control sheets arranged like above at a certain time interval, it is possible to control stored grain insect pests over a long period of time. As such, with the use of the three-dimensional insect control sheet arranged like above, it is possible to easily control insect pests over a long period of time even in places that are difficult to clean.

As described above, the above arrangement shows an insect control effect with respect to any places where larvae are likely to reproduce, and also makes it possible to easily control insect pests even in places that are difficult to clean.

As such, the above arrangement shows an insect control effect on larvae of stored grain insect pests inside powder heaps, which could not easily been controlled by conventional techniques, and makes it possible to easily control insect pests even in places that are difficult to clean.

Note that the insect growth regulator is an agent that serves to (i) inhibit the hatching of eggs of stored grain insect pests or (ii) inhibit the growth of or adult eclosion from larvae of stored grain insect pests.

A three-dimensional insect control sheet in accordance with a second aspect of the present invention can be arranged such that the three-dimensional surface has a corrugated structure.

According to the above arrangement, since the three-dimensional surface has a corrugated structure, when the three-dimensional insect control sheet is placed in advance in a place where powder heaps are likely to form, recesses in the corrugated shape will have grain powder deposited thereon and powder heaps will form. Thus, the above arrangement shows an excellent insect control effect on the stored grain insect pests that occur in the powder heaps deposited in the recesses in the corrugated shape.

A three-dimensional insect control sheet in accordance with a third aspect of the present invention can be arranged such that the three-dimensional surface has a structure that includes projections.

According to the above arrangement, since the three-dimensional surface has a structure that includes projections, when the three-dimensional insect control sheet is placed in advance in a place where powder heaps are likely to form, spaces between the projections will have grain powder deposited thereon and powder heaps will form. Thus, the above arrangement shows an excellent insect control effect on the stored grain insect pests that occur in the powder heaps deposited in the spaces between the projections.

A three-dimensional insect control sheet in accordance with a fourth aspect of the present invention can be arranged such that the three-dimensional surface has a structure that includes a plurality of compartments separated by walls standing on the front surface.

According to the above arrangement, since the three-dimensional surface has a structure that includes a plurality of compartments separated by walls standing on the front surface, when the three-dimensional insect control sheet is placed in advance in a place where powder heaps are likely to form, the compartments will have grain powder deposited therein and powder heaps will form. Thus, the above arrangement shows an excellent insect control effect on the stored grain insect pests that occur in the powder heaps deposited in the compartments.

A three-dimensional insect control sheet in accordance with a fifth aspect of the present invention is preferably arranged such that the structure with the irregular profile has a height of 5 mm to 30 mm. The heights in this range are suitable from the viewpoints of convenience and insect control effect.

A three-dimensional insect control sheet in accordance with a sixth aspect of the present invention can be arranged such that the sheet further includes an adhesive layer.

According to the above arrangement, since the adhesive layer is provided, the three-dimensional insect control sheet can be used over a long period of time without falling even if the sheet is placed in, for example, a place at height.

A three-dimensional insect control sheet in accordance with a seventh aspect of the present invention can be arranged such that the sheet is targeted at one or two or more stored grain insect pests selected from the group consisting of insects under the family Curculionidae, insects under the family Silvanidae, insects under the family Pyralidae, insects under the family Anobiidae, and insects under the family Tenebrionidae.

A three-dimensional insect control sheet in accordance with an eighth aspect of the present invention is preferably arranged such that the insect growth regulator contains pyriproxyfen as an active ingredient.

A three-dimensional insect control sheet in accordance with a ninth aspect of the present invention is preferably arranged such that recesses in the three-dimensional surface serve as portions where grain powder deposits and powder heaps form.

With this, when placed in advance in a place where powder heaps are likely to form, the three-dimensional insect control sheet shows an excellent insect control effect on stored grain insect pests.

### EXAMPLES

### Production Example 1

A sheet of filter paper (ADANTEC qualitative filter paper NO. 2, available form Toyo Roshi Kaisha, Ltd.) was formed into a corrugated form such that the height in the Z axis direction was 10 mm and the angle of each vertex was 50°, and then an agent solution obtained by dissolving pyriproxyfen (available from Sumitomo Chemical Co., Ltd.) in 2-propanol (available from KANTO CHEMICAL CO., INC.) was applied to the sheet at a rate of 5 mg pyriproxyfen per square meter (x axis×y axis) of the sheet, and dried. In this way, a three-dimensional insect control sheet 1-1 was prepared.

### Production Example 2

The same process as described in Production Example 1 was carried out, except that the amount of application of pyriproxyfen was changed to 1000 mg per square meter of the sheet. In this way, a three-dimensional insect control sheet 1-2 was prepared.

### Production Example 3

A sheet of non-woven polyethylene terephthalate fabric (MARIX #82007BSO, available from UNITIKA LTD.) was formed into a corrugated form such that the height in the Z axis direction was 10 mm and the angle of each vertex was 50°, and then an agent solution obtained by dissolving pyriproxyfen (available from Sumitomo Chemical Co., Ltd.) in 2-propanol (available from KANTO CHEMICAL CO., INC.) was applied to the sheet at a rate of 1000 mg pyriproxyfen per square meter (x axis×y axis) of the sheet, and dried. In this way, a three-dimensional insect control sheet 1-3 was prepared.

### Comparative Production Example 1

An agent solution obtained by dissolving pyriproxyfen (available from Sumitomo Chemical Co., Ltd.) in 2-propanol (available from KANTO CHEMICAL CO., INC.) was applied to a sheet of filter paper (ADANTEC qualitative filter paper NO. 2 available from Toyo Roshi Kaisha, Ltd.) at a rate of 5 mg pyriproxyfen per square meter (x axis×y axis) of the sheet, and dried. In this way, a flat insect control sheet A-1 was prepared.

### Comparative Production Example 2

The same process as described in Comparative Production Example 1 was carried out, except that the amount of application of pyriproxyfen was changed to 1000 mg per square meter of the sheet. In this way, a flat insect control sheet A-2 was prepared.

### Comparative Production Example 3

An agent solution obtained by dissolving pyriproxyfen (available from Sumitomo Chemical Co., Ltd.) in 2-propanol (available from KANTO CHEMICAL CO., INC.) was applied to a sheet of non-woven polyethylene terephthalate fabric (MARIX #82007BSO, available from UNITIKA LTD.) at a rate of 1000 mg pyriproxyfen per square meter (x axis×y axis) of the sheet, and dried. In this way, a flat insect control sheet A-3 was prepared.

### Effectiveness Test Method 1

The three-dimensional insect control sheet 1-1 and the flat insect control sheet A-1 were each cut into a circular piece of 8.5 cm in diameter, and were placed on the bottoms of respective different glass containers (each having a diameter of 9 cm and a height of 10 cm). Then, 40 grams of graham flour (Product Name: DC whole wheat flour, available from THE TORIGOE CO., LTD.) was added onto each of the sheets in the glass containers. Then, 15 adult red flour beetles (Tribolium castaneum) were released into each of the glass containers, and allowed to stand at 25° C. A control sample, which is a container having placed thein a sheet of filter paper with no pyriproxyfen applied, was also prepared and, in the same manner as described above, 40 grams of graham flour was added onto the filter paper, 15 adult red flour beetles were released thereto, and allowed to stand at 25° C. The adult beetles released into the glass containers were removed from the containers seven days later. Then, the glass containers were allowed to stand at 25° C. and, 11 weeks after the date of removal of the adult beetles, the number of adult beetles eclosed within each container was counted. The number of adults eclosed within the container having the three-dimensional insect control sheet 1-1 or the flat insect control sheet A-1 placed therein and the number of adults eclosed within the section not treated with the agent (hereinafter referred to as untreated section) were used to calculate insect pest control rate.

The insect pest control rate was calculated using the following equation, where “agent-treated section” refers to a test section treated with pyriproxyfen and “untreated section” refers to a test section not treated with pyriproxyfen.

Insect pest control rate (%)=(the number of adult insects eclosed in untreated section−the number of adult insects eclosed in agent-treated section)/the number of adult insects eclosed in untreated section

The results of the effectiveness test are shown in Table 1. An insect pest control rate of 80% to 100% was ranked as “A”, an insect pest control rate of 50% to 79% was ranked as “B”, and an insect pest control rate of less than 50% was ranked as “C”.

TABLE 1

| | Production Example 1 | Comparative |
|---|---|---|
| | (three-dimensional | Production Example 1 |
| | insect control sheet | (flat insect control |
| | 1-1) | sheet A-1) |
| Effectiveness | A | C |
| test 1 | | |

### Effectiveness Test Method 2

The three-dimensional insect control sheet 1-1 and the flat insect control sheet A-1 were each cut into a circular piece of 8.5 cm in diameter, and were placed on the bottoms of respective different glass containers (each having a diameter of 9 cm and a height of 10 cm). Then, 40 grams of graham flour (Product Name: DC whole wheat flour, available from THE TORIGOE CO., LTD.) was added onto each of the sheets in the glass containers. Then, 15 adult sawtoothed grain beetles (Oryzaephilus surinamensis) were released into each of the glass containers, and allowed to stand at 25° C. A control sample, which is a container having placed thein a sheet of filter paper with no pyriproxyfen applied, was also prepared and, in the same manner as described above, 40 grams of graham flour was added onto the filter paper, 15 adult sawtoothed grain beetles were released thereto, and allowed to stand at 25° C. The adult beetles released into the glass containers were removed from the containers seven days later. Then, the glass containers were allowed to stand at 25° C. and, 15 weeks after the date of removal of the adult beetles, the number of adult beetles eclosed within each container was counted. The number of adults eclosed within the container having the three-dimensional insect control sheet 1-1 or the flat insect control sheet A-1 placed therein and the number of adults eclosed within the untreated section were used to calculate insect pest control rate.

The insect pest control rate was calculated using the following equation, where “agent-treated section” refers to a test section treated with pyriproxyfen and “untreated section” refers to a test section not treated with pyriproxyfen.

Insect pest control rate (%)=(the number of adult insects eclosed in untreated section−the number of adult insects eclosed in agent-treated section)/the number of adult insects eclosed in untreated section

The results of the effectiveness test are shown in Table 2. An insect pest control rate of 80% to 100% was ranked as “A”, an insect pest control rate of 50% to 79% was ranked as “B”, and an insect pest control rate of less than 50% was ranked as “C”.

TABLE 2

| | Production Example 1 | Comparative |
|---|---|---|
| | (three-dimensional | Production Example 1 |
| | insect control sheet | (flat insect control |
| | 1-1) | sheet A-1) |
| Effectiveness | A | C |
| test 2 | | |

### Effectiveness Test Method 3

The three-dimensional insect control sheet 1-2 and the flat insect control sheet A-2 were each cut into a circular piece of 8.5 cm in diameter, and were placed on the bottoms of respective different glass containers (each having a diameter of 9 cm and a height of 10 cm). Then, 30 grams of laboratory animal feed (Product Name: MF powder, available from Oriental Yeast Co., ltd.) was added onto each of the sheets in the glass containers. Then, 15 adult cigarette beetles (Lasioderma serricorne) were released into each of the glass containers, and allowed to stand at 25° C. A control sample, which is a container having placed thein a sheet of filter paper with no pyriproxyfen applied, was also prepared and, in the same manner as described above, 30 grams of laboratory animal feed was added onto the filter paper, 15 adult cigarette beetles were released thereto, and allowed to stand at 25° C. The adult beetles released into the glass containers were removed from the containers seven days later. Then, the glass containers were allowed to stand at 25° C. and, 14 weeks after the date of removal of the adult beetles, the number of adult beetles eclosed within each container was counted. The number of adults eclosed within the container having the three-dimensional insect control sheet 1-2 or the flat insect control sheet A-2 placed therein and the number of adults eclosed within the untreated section were used to calculate insect pest control rate.

The insect pest control rate was calculated using the following equation, where “agent-treated section” refers to a test section treated with pyriproxyfen and “untreated section” refers to a test section not treated with pyriproxyfen.

Insect pest control rate (%)=(the number of adult insects eclosed in untreated section-the number of adult insects eclosed in agent-treated section)/the number of adult insects eclosed in untreated section

The results of the effectiveness test are shown in Table 3. An insect pest control rate of 80% to 100% was ranked as “A”, an insect pest control rate of 50% to 79% was ranked as “B”, and an insect pest control rate of less than 50% was ranked as “C”.

TABLE 3

| | Production Example 2 | Comparative |
|---|---|---|
| | (three-dimensional | Production Example 2 |
| | insect control sheet | (flat insect control |
| | 1-2) | sheet A-2) |
| Effectiveness | A | B |
| test 3 | | |

### Effectiveness Test Method 4

The three-dimensional insect control sheet 1-3 and the flat insect control sheet A-3 were each cut into a circular piece of 8.5 cm in diameter, and were placed on the bottoms of respective different glass containers (each having a diameter of 9 cm and a height of 10 cm). Then, 30 grams of laboratory animal feed (Product Name: MF powder, available from Oriental Yeast Co., ltd.) was added onto each of the sheets in the glass containers. Then, 15 adult cigarette beetles (Lasioderma serricorne) were released into each of the glass containers, and allowed to stand at 25° C. A control sample, which is a container having placed thein a sheet of filter paper with no pyriproxyfen applied, was also prepared and, in the same manner as described above, 30 grams of laboratory animal feed was added onto the filter paper, 15 adult cigarette beetles were released thereto, and allowed to stand at 25° C. The adult beetles released into the glass containers were removed from the containers seven days later. Then, the glass containers were allowed to stand at 25° C. and, 15 weeks after the date of removal of the adult beetles, the number of adult beetles eclosed within each container was counted. The number of adults eclosed within the container having the three-dimensional insect control sheet 1-3 or the flat insect control sheet A-3 placed therein and the number of adults eclosed within the untreated section were used to calculate insect pest control rate.

The insect pest control rate was calculated using the following equation, where “agent-treated section” refers to a test section treated with pyriproxyfen and “untreated section” refers to a test section not treated with pyriproxyfen.

Insect pest control rate (%)=(the number of adult insects eclosed in untreated section-the number of adult insects eclosed in agent−treated section)/the number of adult insects eclosed in untreated section

The results of the effectiveness test are shown in Table 4. An insect pest control rate of 80% to 100% was ranked as “A”, an insect pest control rate of 50% to 79% was ranked as “B”, and an insect pest control rate of less than 50% was ranked as “C”.

TABLE 4

| | Production Example 3 | Comparative |
|---|---|---|
| | (three-dimensional | Production Example 3 |
| | insect control sheet | (flat insect control |
| | 1-3) | sheet A-3) |
| Effectiveness | A | B |
| test 4 | | |

### REFERENCE SIGNS LIST

1, 4, 6 sheet body
1a, 4a, 6a front surface
1b back surface
1c ridges
1d, 1d′ valleys
2 adhesive sheet (adhesive layer)
4b base
5 projections
6b walls
6c compartments
10, 10′, 10A, 10B, 10C three-dimensional insect control sheet

1. A method for controlling an insect, comprising:
placing a three-dimensional insect control sheet in a place where grain powder is likely to deposit,
the three-dimensional insect control sheet having a three-dimensional surface that forms a structure with an irregular profile, the three-dimensional insect control sheet comprising an insect growth regulator, the insect growth regulator being contained at least in a front surface of the three-dimensional insect control sheet,
the front surface being at least part of the structure with the irregular profile,
the structure with the irregular profile having recesses on which grain powder is depositable and powder heaps are formable,
the three-dimensional surface having a corrugated structure,
the corrugated structure being a structure which has inclined faces and in which ridges and valleys are repeated along an in-plane direction of the sheet body,
when the three-dimensional insect control sheet is not yet placed in the place where grain powder is likely to deposit, no grain powder being deposited on the three-dimensional insect control sheet.

2. A method for controlling an insect, comprising:
placing a three-dimensional insect control sheet in a place where grain powder is likely to deposit,
the three-dimensional insect control sheet having a three-dimensional surface that forms a structure with an irregular profile, the three-dimensional insect control sheet comprising an insect growth regulator, the insect growth regulator being contained at least in a front surface of the three-dimensional insect control sheet,
the front surface being at least part of the structure with the irregular profile,
the structure with the irregular profile having recesses on which grain powder is depositable and powder heaps are formable,
the three-dimensional surface having a structure that includes a plurality of compartments separated by walls standing on the front surface,
the recesses of the compartments being constituted by the walls and the front surface,
when the three-dimensional insect control sheet is not yet placed in the place where grain powder is likely to deposit, no grain powder being deposited on the three-dimensional insect control sheet.

3. The method as set forth in claim 1, wherein the structure with the irregular profile has a height of 5 mm to 30 mm.

4. The method as set forth in claim 1, wherein the three-dimensional insect control sheet further comprises an adhesive layer.

5. The method as set forth in claim 1, wherein the insect is one or two or more stored grain insect pests selected from the group consisting of Curculionidae, Silvanidae, Pyralidae, Anobiidae, and Tenebrionidae.

6. The method as set forth in claim 1, wherein the insect growth regulator contains pyriproxyfen as an active ingredient.

7. The method as set forth in claim 1, wherein the front surface that contains the insect growth regulator is constituted by non-woven polypropylene fabric or non-woven polyethylene terephthalate fabric.

8. The method as set forth in claim 2, wherein the structure with the irregular profile has a height of 5 mm to 30 mm.

9. The method as set forth in claim 2, wherein the three-dimensional insect control sheet further comprises an adhesive layer.

10. The method as set forth in claim 2, wherein the insect is one or two or more stored grain insect pests selected from the group consisting of Curculionidae, Silvanidae, Pyralidae, Anobiidae, and Tenebrionidae.

11. The method as set forth in claim 2, wherein the insect growth regulator contains pyriproxyfen as an active ingredient.

12. The method as set forth in claim 2, wherein the front surface that contains the insect growth regulator is constituted by non-woven polypropylene fabric or non-woven polyethylene terephthalate fabric.
